(19) United States
(12) Patent Application Publication
(10) Pub. No.: US 2021/0348920 A1
(43) Pub. Date: Nov. 11, 2021

(54) Object Position Estimation Device and Method Therefor

(71) Applicant: Hitachi, Ltd., Chiyoda-ku, Tokyo (JP)

(72) Inventors: Takumi NITO, Tokyo (JP); Qingzhu DUAN, Tokyo (JP)

(21) Appl. No.: 17/278,090

(22) PCT Filed: Sep. 10, 2019
(86) PCT No.: PCT/JP2019/035450

§ 371 Date: Mar. 19, 2021

(30) Foreign Application Priority Data
Feb. 1, 2019 (JP) 2019-017210

(51) Int. Cl. G01C 5/00; G06T 7/73; G06T 7/207; G06T 7/292; G06T 7/62; G06K 9/00

(52) U.S. Cl. CPC G01C 5/00; G06T 7/74; G06T 7/207; G06T 7/292; G06K 2209/21; G06K 9/00369; G06K 9/00342; G06T 2207/30196; G06T 7/62

(57) ABSTRACT

The purpose of this invention is to reduce the ambiguity in position caused by height differences in an object, and to estimate the position of an object with a high degree of accuracy. This object position estimation device comprises: a first processing unit which detects the position of a position reference point on a moving object from an image of the moving object obtained by a camera; a second processing unit for estimating the height of the moving object detected; a third processing unit for estimating the height of the position reference point on the basis of the estimated height estimated by the second processing unit and the image of the moving object; a fourth processing unit which calculates an estimated position candidate for the moving object on the basis of the height of the position reference point estimated by the third processing unit, the position of the position reference point, and the height of the point in the area; a fifth processing unit which calculates the likelihood of the estimated position candidate on the basis of the estimated position candidate calculated by the fourth processing unit, the height of the position reference point estimated by the third processing unit, and the height in the area; and a sixth processing unit which determines the estimated position of the moving object on the basis of the likelihood of the estimated position candidate calculated by the fifth processing unit.

### TECHNICAL FIELD

The present invention relates to an object position estimation device and a method therefor, particularly, to an estimation processing technique of an object position for estimating a position of a moving object such as a person by using an image captured by a camera.

### BACKGROUND ART

Various techniques for estimating the position of a person appearing in an image by using an image captured by a camera are known. For example, Patent Document 1 discloses a technique for using multiple cameras of which calibration is performed and camera parameters are obtained, so as to reduce erroneous position estimation based on an imaginary object when obtaining an object position captured by the multiple cameras with a visual volume intersection method. In addition, Patent Document 2 discloses a technique for detecting a person from multiple camera videos and estimating a three-dimensional position of each person by stereoscopic viewing.

### CITATION LIST

### Patent Document

Patent Document 1: International Publication WO2010/126071 (JP 5454573 B2)
Patent Document 2: JP 2009-143722 A

### Non-Patent Document

Non-Patent Document 1: “Jifeng Dai, “R-FCN: object detection via region-based fully convolutional networks”, International Conference on Neural Information Processing Systems, 2016”
Non-Patent Document 2: “Russell Stewart, “End-to-end people detection in crowded scenes”, IEEE Conference on Computer Vision and Pattern Recognition, 2016”
Non-Patent Document 3: “Zhe Cao, “Realtime Multi-Person 2D Pose Estimation using Part Affinity Fields”, IEEE Conference on Computer Vision and Pattern Recognition, 2017”

### SUMMARY OF THE INVENTION

### Problems to be Solved by the Invention

There is a technique for detecting the position of a customer in a store from a video of a surveillance camera and analyzing the movement of the customer to utilize the movement of the customer for marketing. In addition, there is a need to install a surveillance camera in a place such as a factory or a power plant, grasp the position of a worker by analyzing a video of the surveillance camera, and issue alerts to the worker or a supervisor when the worker approaches a dangerous place, and thus to utilize the video in safety management or assistance for the supervisor to recognize the status of the worker. In a place such as a factory or a power plant, there are many shields and there may be height differences on the floor.

In the technique in Patent Document 1, an object to be detected needs to appear by multiple cameras. Thus, in a place having many shields, the number of cameras increases in a case where cameras are intended to be arranged so that the object to be detected appears by multiple cameras at all points. Thus, cost increases.

Further, the technique in Patent Document 2 is a technique mainly assuming a flat place with no process difference, such as an elevator, and it is not possible to apply to a place having a height difference, such as a factory or a power plant. For example, if a camera is disposed at an angle allowing the camera to look down, in a place having a height difference, there is a possibility that a person in a high place in the foreground and a person in a low place in the back when viewed from the camera appear at the same position on a screen. Thus, in the technique in Patent Document 2, the positions of the persons are ambiguous.

Thus, an object of the present invention is to reduce the ambiguity in position caused by a height difference in an object, and to estimate the position of an object with a high degree of accuracy.

### Solutions to Problems

According to the present invention, preferably, an object position estimation device includes an input and output unit, a storage unit, and a processing unit and estimates a position of a moving object in a three-dimensional space based on images of the moving object, which are acquired by multiple cameras. The object position estimation device is configured so that the storage unit stores area information including a height of each point in an area being a target of image capturing of the cameras, the processing unit includes a first processing unit that detects a position of a position reference point of the moving object, from an image of the moving object acquired by the camera, a second processing unit that estimates a height of the detected moving object, a third processing unit that estimates a height of the position reference point based on the image of the moving object and an estimated height estimated by the second processing unit, a fourth processing unit that calculates an estimated position candidate of the moving object based on the height of the point in the area, the position of the position reference point, and the height of the position reference point, which is estimated by the third processing unit, a fifth processing unit that calculates a likelihood of the estimated position candidate based on a height in the area, the height of the position reference point, which is estimated by the third processing unit, and the estimated position candidate calculated by the fourth processing unit, and a sixth processing unit that determines an estimated position of the moving object based on the likelihood of the estimated position candidate, which is calculated by the fifth processing unit.

Further, the present invention is grasped as an object position estimation method performed by the processing unit in the object position estimation device.

### Effects of the Invention

According to the present invention, it is possible to reduce the ambiguity in position caused by a height difference and to estimate the position of an object with a high degree of accuracy even in a place with a shield or a height difference.

### BRIEF DESCRIPTION OF THE DRAWINGS

FIG. 1 is a diagram illustrating a configuration of an image processing system.

FIG. 2 is a diagram illustrating a configuration example of an object position estimation device.

FIG. 3 is a flowchart illustrating a processing operation of camera calibration.

FIG. 4 is a flowchart illustrating a processing operation of person position estimation.

FIG. 5A is a diagram illustrating an example of an area height.

FIG. 5B is a diagram illustrating a configuration example of an area information table.

FIG. 6 is a diagram illustrating a configuration example of a detected-person information table.

FIG. 7 is a diagram illustrating a configuration example of a person-position candidate information table.

FIG. 8 is a flowchart illustrating a processing operation of person position candidate calculation of multiple cameras.

FIG. 9 is a diagram illustrating a person-position candidate-integrated position relation.

### MODE FOR CARRYING OUT THE INVENTION

In the preferred aspect of the present invention, the followings are performed so that it is possible to estimate the position of a person so long as the person appears by one camera even though there is a shield. Camera calibration is performed. An image of a person is captured using a camera of which a camera parameter is acquired. The person is detected from the captured image, and the height of the photographed person is estimated. Then, a straight line from the camera to the head of the person or a specific point is calculated, and a location at which an estimated height of the photographed person is equal to the height of the straight line from the ground is set as the estimated position of the person from height information of each point in an area, which is acquired in advance. Further, a method of improving the accuracy using multiple cameras is used to avoid the ambiguity of the estimated person position in a certain place having a height difference. A point in which multiple straight lines from the cameras to the detected person intersect with each other (distance between the straight lines is equal to or less than a threshold value) is set as a candidate for a person position. A likelihood of whether or not the person is at the candidate point is calculated from an image feature amount of the person detected by the cameras for the straight line having a intersect, the estimated height, and the height of a intersect point from the ground. Then, a point having a high likelihood is set as the estimated person position. Note that, the position estimation is not limited to a person, and may set a moving object as a target. In addition, when an image capturing target range of a camera is the inside of a building, a reference surface for estimating the height of a moving object can be set to the floor instead of the ground.

Hereinafter, examples will be described with reference to the drawings.

### Example 1

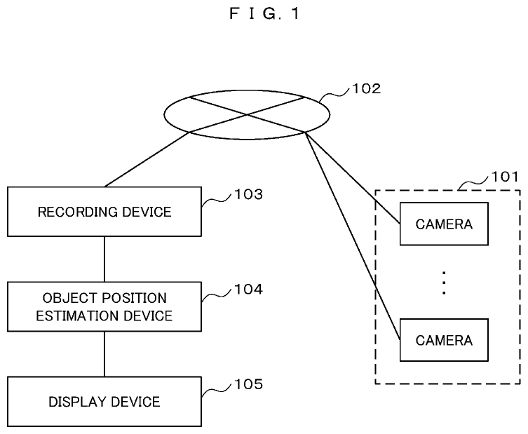

FIG. 1 illustrates an example of an image processing system to which an object position estimation device is applied, according to an example.

The image processing system is configured in a manner that multiple cameras 101 that capture an image of a space and a recording device 103 that records the captured image are connected to a network 102. The recording device 103 accumulates a video set acquired by the multiple cameras 101. The object position estimation device 104 performs person position estimation using the images accumulated in the recording device 103, and displays the result on a display device 105. Note that, the recording device 103, the object position estimation device 104, and the display device 105 may be configured by one computer. Further, the network 102 may be wired or linked via a wireless access point.

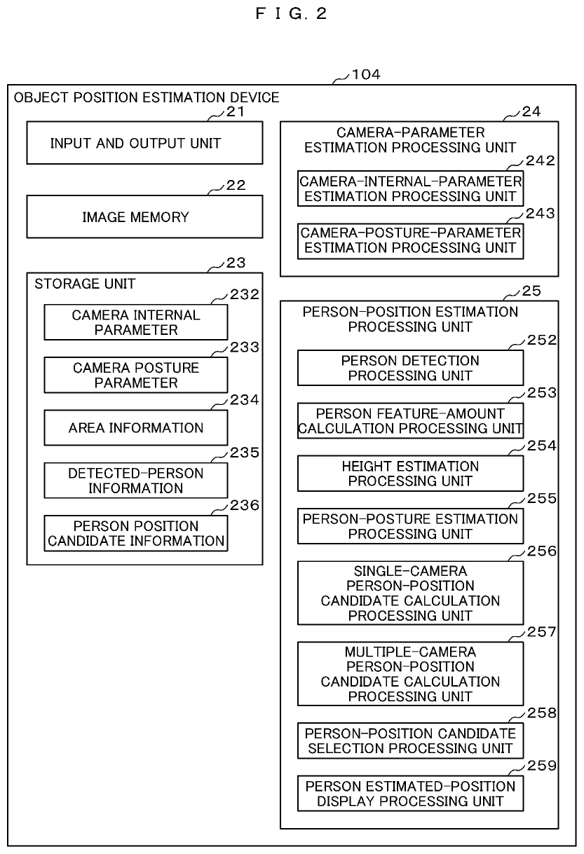

The internal configuration of the object position estimation device 104 will be described with reference to FIG. 2.

The object position estimation device 104 is a computer including a processor and a memory and is configured to include an input and output unit 21, an image memory 22, a storage unit 23, a camera-parameter estimation processing unit 24, and a person-position estimation processing unit 25. The image memory 22 and the storage unit 23 are provided in the memory. The camera-parameter estimation processing unit 24 and the person-position estimation processing unit 25 are functions realized in a manner that the processor executes a program stored in the memory.

In the object position estimation device 104, the input and output unit 21 acquires the image recorded in the recording device 103, and the acquired image is stored in the image memory 22. Further, the input and output unit 21 acquires data input from a device operated by a user. The acquired data is transmitted to the storage unit 23 or the camera-parameter estimation processing unit 24. In addition, the input and output unit 21 outputs a result of the person-position estimation processing unit 25 to the display device 105, and the result is displayed on the display device 105.

The storage unit 23 stores pieces of information that are an internal parameter 232 in which the focal distance, the aspect ratio, the optical center, and the like of the camera are stored, a camera posture parameter 233 in which the position, the direction, and the like of the camera are stored, area information 234 in which the height of each point in an area appearing by the camera is stored, detected-person information 235 in which information regarding the person detected from the image is stored, and detected-person position candidate information 236 in which position candidate information of the detected person is stored. Such pieces of information are configured, for example, in a format of a table. (Details will be described later.)

The camera-parameter estimation processing unit 24 is configured by a camera-internal-parameter estimation processing unit 242 and a camera-posture-parameter estimation processing unit 243. The camera-internal-parameter estimation processing unit 242 estimates the camera internal parameter from an image obtained by capturing a calibration pattern. The camera-posture-parameter estimation processing unit 243 estimates a camera posture parameter (also referred to as an external parameter) from the camera internal parameter, the captured image, positions of a point on multiple image input from the user, and coordinates of the point in a three-dimensional space. Details of each piece of processing will be described later.

The person-position estimation processing unit 25 is configured by a person detection processing unit 252, a person feature-amount calculation processing unit 253, a height estimation processing unit 254, a person-posture estimation processing unit 255, a single-camera person-position candidate calculation processing unit 256, a multiple-camera person-position candidate calculation processing unit 257, a person-position candidate selection processing unit 258, and a person estimated-position display processing unit 259. The person detection processing unit 252 detects the position of a person appearing on an image from the captured image. The person feature-amount calculation processing unit 253 calculates the feature amount of the detected person. The height estimation processing unit 254 estimates the height of the detected person. The person-posture estimation processing unit 255 estimates the posture of the detected person. The single-camera person-position candidate calculation processing unit 256 calculates candidates for a person position for one camera, from the detected-person information 235. The multiple-camera person-position candidate calculation processing unit 257 integrates pieces of person position candidate information 208 of the multiple cameras to improve the accuracy of the person position candidate. The person-position candidate selection processing unit 258 selects the estimated person position from the person position candidate information 236 obtained by integrating pieces of information of the multiple cameras. The person estimated-position display processing unit 259 displays the estimated person position on the display device 105. Details of each piece of processing will be described later.

In the example illustrated in FIGS. 1 and 2, assuming an environment captured by three cameras, the person position estimation is performed. The three cameras are set as a camera A, a camera B, and a camera C, respectively. Regarding the arrangement of the cameras, it is desirable to arrange the cameras in an area in which person position estimation is performed, so that two or more cameras capture an image of a space in which position estimation is ambiguous with one camera due to a height difference, as many as possible. As the cameras A to C, cameras that commercially used as network cameras can be used. It is assumed that time points of the internal clocks in the cameras are synchronized in advance using NTP or the like to coincide with each other. An image captured by each camera is transmitted to the recording device 103 via the network 102 and recorded together with an ID of the camera and an image capturing time point.

The person position estimation is divided into a first stage of preparation and a second stage. In the first stage, the camera internal parameter, the camera posture parameter, and the area information are set. In the second stage, the position of a person appearing in an image is estimated from a camera image and information set in advance.

The first stage of setting the information in advance is further divided into a 1-1st stage and a 1-2nd stage. In the 1-1st stage, the camera internal parameter and the camera posture parameter are set by calibration. In the 1-2nd stage, the area information input by the user is set.

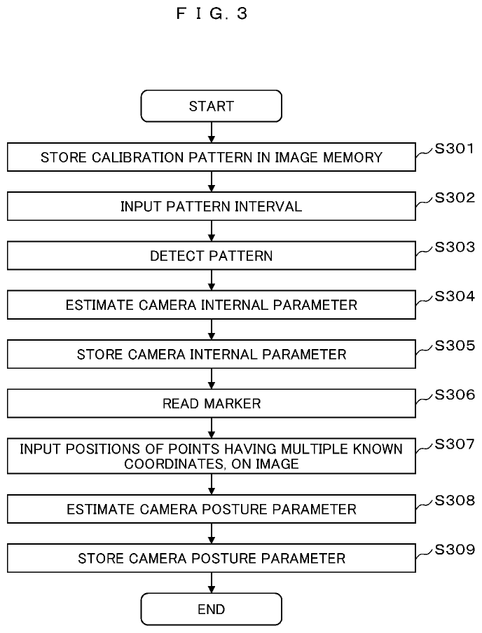

Next, processing of setting the camera internal parameter and the camera posture parameter by calibration will be described with reference to FIG. 3. Such processing is performed by the camera-parameter estimation processing unit 24. Here, the flowchart in FIG. 3 illustrates a processing operation of one camera. For example, in the case of three cameras A to C, the same processing is performed for each camera. Further, data stored in the camera internal parameter 232 and the camera posture parameter 233 is also individually stored together with the ID of each camera of the cameras A to C.

In calibration on each camera, values of parameters in Formula 1 and Formula 2 are obtained. Formula 1 is an expression in which a relation between three-dimensional coordinates (X, Y, Z) in a world coordinate system and pixel coordinates (u, v) on the image in the case of a pinhole camera model without lens distortion is expressed in homogeneous coordinate representation.

$$\begin{matrix}[ Math . 1 ] & \\ [ \begin{matrix}u \\ v \\ 1\end{matrix} ] \sim [ \begin{matrix}fx & s & cx \\ 0 & fy & cy \\ 0 & 0 & 1\end{matrix} ] [ \begin{matrix}R 11 & R 12 & R 13 & tx \\ R 21 & R 22 & R 23 & ty \\ R 31 & R 32 & R 33 & Tz\end{matrix} ] [ \begin{matrix}X \\ Y \\ Z \\ 1\end{matrix} ] & Formula 1 \\ [ Math . 2 ] & \\ {u}^{′} = u ( 1 + {k}_{1} {r}^{2} + {k}_{2} {r}^{4} + {k}_{3} {r}^{6} ) + 2 {p}_{1} uv + {p}_{2} ( {r}^{2} + 2 {u}^{2} ) \\ {v}^{′} = v ( 1 + {k}_{1} {r}^{2} + {k}_{2} {r}^{4} + {k}_{3} {r}^{6} ) + {p}_{1} ( {r}^{2} + 2 {u}^{2} ) + 2 {p}_{2} uv \\ {r}^{2} = {u}^{2} + {v}^{2} & Formula 2\end{matrix}$$

In the world coordinate system, the XY plane is set to be a horizontal plane, and a Z-axis is set to be the vertical direction. (fx, fy) indicates the focal distance in units of pixels. (cx, cy) indicates the optical center in units of pixels. s indicates the shear coefficient of a pixel. R11 to R33 and tx to tz indicate postures of the cameras. Lens distortion occurs in the actual camera. In a formula representing a relation between coordinates (u, v) on the image when there is no distortion and coordinates (u′, v′) when distortion occurs, k1, k2, and k3 indicate distortion coefficients in a radial direction, and p1 and p2 indicates distortion coefficients in a circumferential direction. The camera internal parameters are (fx, fy), (cx, cy), s, k1, k2, k3, p1, and p2. The camera posture parameters are R11 to R33 and tx to tz.

In calibration processing, firstly, the user captures an image of a calibration pattern with the camera. The calibration pattern includes multiple image patterns such as a checker pattern and a dot pattern. The image patterns captured by the camera are stored in the recording device 103. Regarding the number of captured images and the position of the calibration pattern, it is desirable that the number of captured images is equal to or more than about 10, and the pattern appears at various positions on the image.

Then, as described above, the image of the calibration pattern prepared in the recording device 103 is read by the input and output unit 21 and is stored in the image memory 22 (S301).

Then, the length of a calibration pattern interval is input from the input and output unit 21 by an operation of the user (S302). Then, the pattern is detected from the image in which the calibration pattern appears, on the image memory 22 (S303). The pattern can be detected, for example, using “OpenCV being an open source library for computer vision”.

Then, the camera internal parameter is estimated using the pattern interval and the detected pattern (S304). The estimated camera internal parameter is stored in the camera internal parameter 204 together with the camera ID (S305). The parameter can be estimated using “the method of EasyCalib”. The similar method is implemented in “OpenCV being an open source library for computer vision”.

Then, regarding the camera posture parameter, in advance, markers are placed at multiple points having the known three-dimensional space coordinates, and are captured by the camera. The number of markers is desirably at least four and six or more. The markers prepared in this manner are read by the input and output unit 21 (S306). Note that, the image captured by the camera is stored in the recording device 103, similar to the calibration pattern. The input and output unit 21 sequentially reads the images from the recording device and stores the images in the image memory 22.

Then, the three-dimensional coordinates of the marker in the world coordinate system and the pixel coordinates of the marker appearing in the image are input from the input and output unit 21 by the operation of the user (S307). Thus, the camera posture parameters are estimated by solving a PnP problem from the input coordinates and the camera internal parameters (S308) and are stored in the camera posture parameter 233 together with the camera ID (S309). The solution to the PnP problem is implemented in “OpenCV being an open source library for computer vision”.

Regarding the area information, the height of each point in the area appearing by the camera is input from the input and output unit 21 by the operation of the user, and is stored in the area information 234.

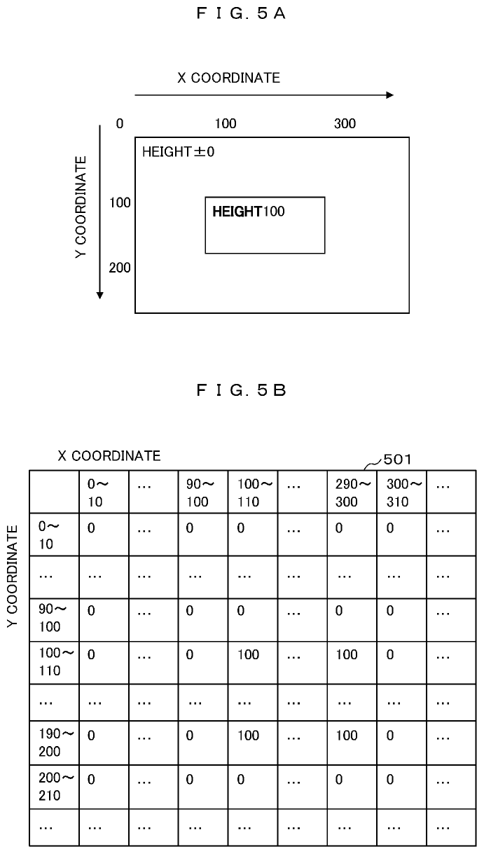

Here, the area information will be described with reference to FIGS. 5A and 5B. FIG. 5A schematically illustrates the area height. FIG. 5B illustrates the area information table (area information 234 in a table format). When the height of the area (height of the ground) is as in FIG. 5A, as with the area information table 501 in FIG. 5B, the area information 234 is stored in the storage unit 23 while the center portion is expressed by the height of “100” mm. In the area information table 501, XY coordinates representing the plane area are divided into predetermined sections in a mesh. The area information table is expressed with the height (Z coordinate) of the area being each mesh in the XY coordinates. In the present example, the size of the section of the XY coordinates is “10”. The size of the section can change depending on the accuracy required in the examples. The processing of estimating the position of a person is performed based on the image of an area captured by the camera, in a situation in which there are multiple people in such an area having a height difference.

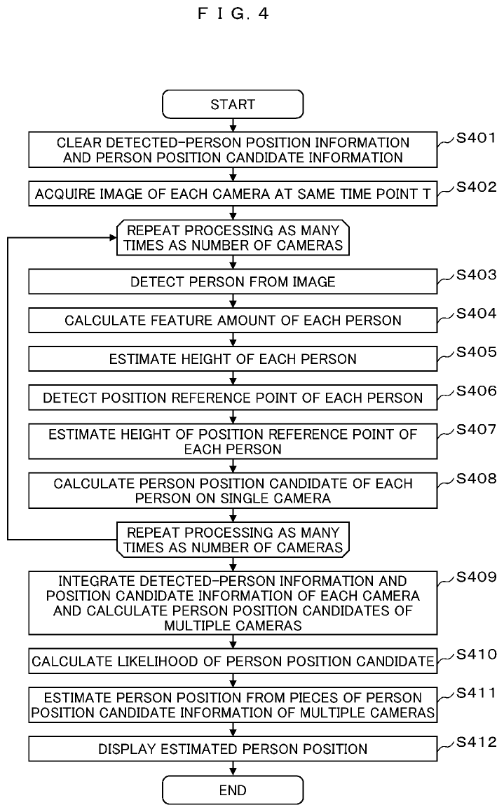

Next, the processing operation of person position estimation by the person-position estimation processing unit 25 will be described with reference to FIG. 4. The example illustrated in FIG. 4 is processing of estimating the person position by using images captured by the cameras A to C at a certain time point T. Every time new images acquired by the cameras A to C are stored in the recording device 103, processing is repeated while updating the time point T to a time point at which the new images are stored. The person position at the current time point is continuously acquired in this manner, and thus the person position is estimated. Pieces of processing as follows are performed by the processing units of the person detection processing unit 252 to the person estimated-position display processing unit 259, respectively.

In person position estimation processing, firstly, the contents of the detected-person information 235 and the person position candidate information 236 used in the previous processing are cleared (S401). Then, the input and output unit 21 acquires images of the cameras A to C at the time point T from the recording device 103 and stores the acquired images in the image memory 22 (S402).

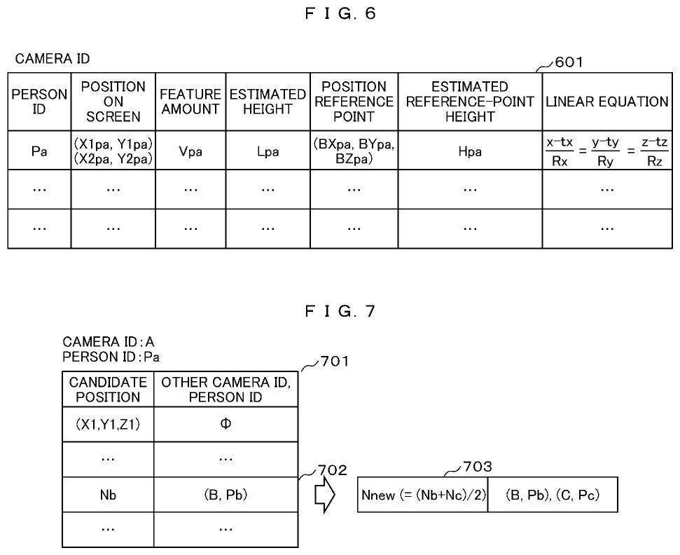

The person detection processing unit 252 performs processes from person detection (S403) on the images of the cameras A to C, which are stored in the image memory 22, to single-camera person-position candidate calculation (S408). In the process S403 of detecting a person from the image, the person can be detected using the method as in Non-Patent Document 1. The detected person information is stored in a format like the detected-person information 235 (detected-person information table 601 in FIG. 6).

As illustrated in FIG. 6, in the detected-person information table configured by assigning the unique camera ID to each camera, an entry is created by assigning a person ID to each person detected from the image. In each entry, regarding the detected position on the image, the pixel coordinates (X1pa, Y1pa) in the upper left and lower right, the feature amount Vpa, the estimated height Lpa of the person, the position reference point (BXpa, BYpa, BZpa), the estimated reference-point height (Hpa), and the linear equation are written.

In the process S404 in which the person feature-amount calculation processing unit 253 calculates the feature amount of each person, the person feature-amount calculation processing unit cuts the detected person out from the original image and calculates an image feature amount. As the image feature amount, a color feature amount that uses a color histogram of the person image as the feature amount, a value of an intermediate layer of a neural network that identifies the age, the gender, the clothes, and the like of the person using deep learning, and the like are used as the feature amount. As the feature amount using the neural network, for example, the feature amount obtained in a manner that the correspondence between the image obtained by cutting out the person, and the age, the gender, and the clothes in the neural network such as so-called AlexNet or ResNet is learned using an error propagation method is used. The value of the intermediate layer when the detected person image is input to the neural network is used as a vector of the feature amount. The calculated feature amount is written in the entry of each detected person ID in the detected-person information table 601.

In the process S405 in which the height estimation processing unit 254 estimates the height of each person, a neural network in which a relation between the person image and the height is learned in advance using deep learning is prepared, and the height is estimated with an input of the detected person image by using the network. As the neural network for estimating the height, similar to the above-described neural network, for example, a neural network in which the correspondence between the image obtained by cutting out the person, and the height in the neural network such as AlexNet or ResNet is learned using the error propagation method is used. Further, when the persons in the area have the heights which are substantially equal to each other, or when the position of the camera is high, the present process may be a process, for example, of setting the fixed height set in advance as the estimated height. The estimated height is written in the entry of each detected person ID in the detected-person information table 601.

In the process S406 in which the person-posture estimation processing unit 255 detects the position reference point of each person, a point (position reference point) as the reference of the person position is detected. A point perpendicular to the ground from the position reference point is set as the coordinates of the person. As the position reference point, a location that has difficulty in being hidden by obstacles and is easily detected from any direction. Specifically, a skeleton is detected from the image of a person, and the posture of the person is estimated based on the position and the angle of the skeleton. For example, the posture is estimated based on the position and the angle of the top of the head of the person, the center of the head, or the center of both shoulders. In the case of the top of the head, the top of the head is a midpoint of the upper side of a person detection frame (on the premise that the person basically has a standing posture). In the case of the center of the head, the head is detected using the method such as the method in Non-Patent Document 2, and there is a center point of the detection frame. In the case of the center of both shoulders, the center of both shoulders can be detected by the method in Non-Patent Document 3 or the like. The pixel coordinates of the detected position reference point on the image are written in the entry of each person ID in the detected-person information table 601.

In the process S407 in which the person-posture estimation processing unit 255 estimates the height of a person position reference point from the ground, the height of the person position reference point from the ground is estimated based on the estimated height and posture information of the person detected by the method in Non-Patent Document 3. the lengths of the head, the upper body, and the lower body are calculated from the height as the standard physique, and the height of the reference point is estimated from the inclination of the detected posture. When it is not possible to see the upper body and the lower body, it is estimated that the upper body or the lower body is vertical. The estimated height of the person position reference point is written in the entry of each detected person ID in the detected-person information table 601.

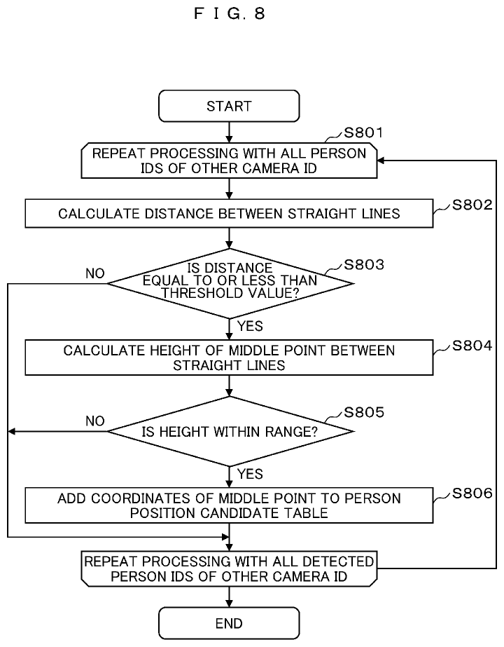

In the process S408 in which the single-camera person-position candidate calculation processing unit 256 calculates a person position candidate of a single camera, firstly, a straight line connecting the camera and the person position reference point is obtained based on the camera internal parameter, the camera posture parameter, and the position of the person position reference point of the detected-person information table 601. The obtained straight line is written in the detected-person information table 601. Calculation can be performed using Formula 1 and Formula 2 in order to obtain the straight line. Then, the height from a point on the straight line to the ground is obtained using the obtained straight line and the area information 234. Then, among points on the straight line, a point of which the height to the ground is equal to the estimated height of the person position reference point is set as the person position candidate. In the case of a place having a height difference, multiple person position candidates may be provided. Regarding the person position candidate, as illustrated in FIG. 7, a person position candidate table 701 (person position candidate information 236 in a table format) is created for each camera ID and person ID, and the calculated person position candidate is stored at a candidate position (X1, Y1, Z1). Further, a person position candidate detected by another camera is stored in the person position candidate table 701 for each camera ID and person ID.

After the processes from the person detection S403 to the single-camera person-position candidate calculation S408 in the flowchart in FIG. 4 on the images of the cameras A to C is ended, the multiple-camera person-position candidate calculation processing unit 257 performs integrates pieces of information of the cameras and performs processing of calculating the person position candidate by the multiple cameras (S409). The process S409 is performed for each combination of the camera ID and the person ID. A formula for a straight line between the camera and the person position reference point is read from the detected-person information table 601 of the camera ID and the person ID that perform processing. Then, the processing of the flowchart in FIG. 8 is performed.

Here, the description will be made with reference to the flowchart in FIG. 8. Processes from the process S801 to the process S806 are repeated for each of all person IDs for a camera ID different from the camera ID as a processing target.

Firstly, a distance between straight lines between each camera and the person reference point with a combination of the camera ID and the person ID of other two cameras (for example, cameras B and C) is calculated (S802). Then, the calculated distance is compared to a threshold value (S803). The threshold value is set to a value which is appropriate and causes high accuracy for each number of times of performing. As a result of the comparison, when the distance is equal to or more than the threshold value (S803: No), the next processes from S801 to S806 are repeated. On the other hand, when the distance is equal to or less than the threshold value (S803: Y), the process transitions to the next process S804.

In the process S804, a middle point between two straight lines of the distance by the processing result is calculated, and the height of the middle point from the ground is calculated from the area information. Then, the height is compared with an assumed person reference point height range (S805). The assumed person reference point height range is set to exclude the impossible height such as the negative height or a height that largely exceeds the height of a person. A range of about 0 cm to 200 cm is appropriate. As a result of the comparison, in the case of being out of the range (S805: No), the next processes of S801 to S806 are repeated. On the other hand, in the case of being within the range (S805: Y), the process transitions to the next process S806.

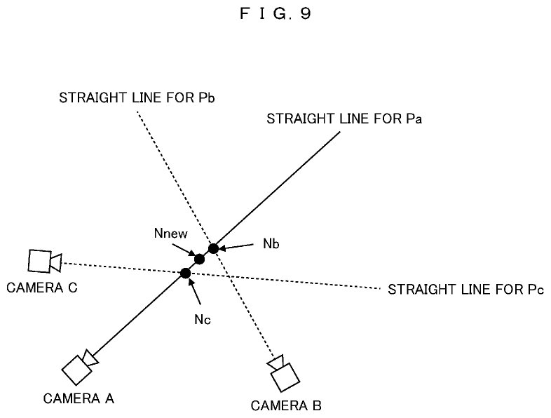

In the process S806, the coordinates of the calculated middle point are added to the entry in the person position candidate table 701. In addition of the entry, the camera ID and the person ID when the middle point is calculated are stored in the table in addition to the coordinates of the position candidate. For example, when a position candidate Nb of the middle point having a camera ID of B and a person ID of Pb is added to a processing target of Pb having a camera ID of A and a person ID of Pa, an entry being an entry 702 in FIG. 7 is added, that is, so that the position candidate is Nb, and another camera ID and person ID is (B, Pb). In a case where, when an entry is added, there is an entry that has been already added in the previous process (S806), and the distance between the position candidate of the entry added previously and a position candidate to be newly added is equal to or less than a threshold value, the entry that has been previously added is updated instead of adding a new entry. The new position candidate is set to an average of the coordinates of the entry that is previously added and the coordinates of the new position candidate. Additional description is performed on another camera ID and person ID. For example, when an entry in which the camera ID is C, the person ID is Pc, and the position candidate is Nc is intended to be added to the entry 702 in the above example, and a distance between Nb and Nc is equal to or less than the threshold value, in the entry to be updated as with 703, the position candidate is Nnew (average of Nb and Nc), and another camera ID and person ID is (B, Pb) and (C, Pc). Such a position relation is as in FIG. 9 when viewed from the above.

Here, returning to the description for FIG. 4, the multiple-camera person-position candidate calculation processing unit 257 performs processing of calculating the likelihood for each of the calculated person position candidates next to the calculation process S409 of the person position candidate of the multiple cameras (S410). For each entry in the person position candidate table 701, the likelihood is calculated in accordance with Formula 3 while data is read from the storage unit 23, and the likelihood of the person position candidate table 701 is added. For example, the likelihood of the entry 703 is calculated as in Formula 4.

$$\begin{matrix}[ Math . 3 ] & \\ Likelihood = \frac{\begin{matrix}\vert Z coordinate of candidate position - \\ area height of candidate \\ position in XY coordinates \vert\end{matrix} }{\begin{matrix}Detected - person estimated height \\ in person position candidate table\end{matrix} } \times ( 1 + {\sum }_{P ∈ Another {camera ID}_{person ID} , detected} Similarity between detected person and P in person position candidate table ) & Formula 3\end{matrix}$$

Similarity between persons Pa and Pb=e^{-(Distance between vectors Vpa and Vpb)}

[Math. 4]

Another camera ID, detected person ID=Pb,Pc

Coordinates of Nnew=(Xnew,Ynew,Znew)

Height of Xnew,Ynew=value of Xnew,Ynew in area information table

Likelihood=|Znew−height of Xnew,Ynew|/Lpa×(1+e^{-|Vpa-Vpb|}+e^{-|Vpa-Vpc|} Formula 4

In “Similarity between persons Pa and Pb=e\hat{ }(−(Distance between vectors Vpa and Vpb))” in Formula 3, the vectors Vpa and Vpb indicate the image and the image feature amount, and the similarity is the similarity of the image feature amount. That is, the likelihood increases as the image feature amounts becomes more similar.

As described above, in a case where the height of the position candidate is closer to the height of the estimated person reference position, the likelihood is high. In addition, in a case where the similarity with the person in the vicinity of the position candidate appearing by another camera is higher, the likelihood is high. Thus, the person-position candidate selection processing unit 258 determines the estimated position of the person position based on the likelihood of the person position candidate table 701 (S411). In determination of the estimated position, the person position candidate table 701 of each detected person in the cameras A to C is sequentially examined, and the person position candidate having the highest likelihood is set to the estimated person position. However, when the entry such as the entry 703 in the person position candidate table 701 is selected as the estimated position in which the camera ID is A and the detected person ID is Pa, the estimated position in which the camera ID is B, and the detected person ID is Pb, and the estimated position in which the camera ID is C, and the detected person ID is PC are also set to be the same.

Finally, the person estimated-position display processing unit 259 displays the calculated estimated person position on the display device 105 (S412). That is, a form obtained in a manner that the estimated person position is transformed into XY coordinates in the horizontal plane, a floor map as illustrated in FIG. 5A is created from the area information, and the estimated person position is plotted on the floor map is displayed on the display device 105 via the input and output unit 201.

### REFERENCE SIGNS LIST

101 Camera
102 Network
103 Recording device
104 Object position estimation device
105 Display device
21 Input and output unit
22 Image memory
23 Storage unit
232 Camera internal parameter
233 Camera posture parameter
234 Area information
235 Detected-person information
236 Person position candidate information
24 Camera-parameter estimation processing unit
242 Camera-internal-parameter estimation processing unit
243 Camera-posture-parameter estimation processing unit
252 Person-position estimation processing unit
252 Person detection processing unit
253 Person feature-amount calculation processing unit
254 Height estimation processing unit
255 Person-posture estimation processing unit
256 Single-camera person-position candidate calculation processing unit
257 Multiple-camera person-position candidate calculation processing unit
258 Person-position candidate selection processing unit
259 Person estimated-position display processing unit

1. An object position estimation device that includes an input and output unit, a storage unit, and a processing unit and estimates a position of a moving object in a three-dimensional space based on images of the moving object, which are acquired by multiple cameras, wherein
the storage unit stores area information including a height of each point in an area being a target of image capturing of the cameras,
the processing unit includes
a first processing unit that detects a position of a position reference point of the moving object, from an image of the moving object acquired by the camera,
a second processing unit that estimates a height of the detected moving object,
a third processing unit that estimates a height of the position reference point based on the image of the moving object and an estimated height estimated by the second processing unit,
a fourth processing unit that calculates an estimated position candidate of the moving object based on the height of the point in the area, the position of the position reference point, and the height of the position reference point, which is estimated by the third processing unit,
a fifth processing unit that calculates a likelihood of the estimated position candidate based on a height in the area, the height of the position reference point, which is estimated by the third processing unit, and the estimated position candidate calculated by the fourth processing unit, and
a sixth processing unit that determines an estimated position of the moving object based on the likelihood of the estimated position candidate, which is calculated by the fifth processing unit.

2. The object position estimation device according to claim 1, wherein
the moving object is a person, and
the second processing unit sets a fixed length as an estimated height of the person.

3. The object position estimation device according to claim 1, wherein
in processing of estimating the height of the position reference point by the third processing unit,
a skeleton is detected from the image of the detected moving object to estimate a posture of the moving object based on a position or an angle of the skeleton, and the height of the position reference point is estimated in accordance with the estimated height.

4. The object position estimation device according to claim 1, further comprising:
a seventh processing unit that calculates a feature amount of the image of the detected moving object, wherein
the fifth processing unit calculates the likelihood of the estimated position candidate using the feature amount calculated by the seventh processing unit.

5. The object position estimation device according to claim 1, wherein
the storage unit stores
an area information table for managing area information, in which a height of each point in the area is expressed as a height coordinate in plane coordinates obtained by dividing the area by a predetermined length, and
a parameter table for managing an internal parameter of the camera and a posture parameter of the camera.

6. The object position estimation device according to claim 1, wherein
the storage unit stores
a detected-object information table for managing coordinates indicating a position of a detected image, the feature amount, the estimated height of the moving object, the position reference point, and estimated reference-point height, in association with an object ID assigned to each object detected from the image, and
an object-position candidate information table for managing a camera ID unique to the camera, the object ID, and information of an estimated object-position candidate, which expresses object position in three-dimensional coordinates.

7. An object position estimation method that includes an input and output unit, a storage unit, and a processing unit and estimates a position of a moving object in a three-dimensional space based on images of the moving object, which are acquired by multiple cameras, the method comprising:
storing area information including a height of each point in an area being a target of image capturing of the cameras by the storage unit; and
performing, by the processing unit,
first processing of detecting a position of a position reference point of the moving object, from an image of the moving object acquired by the camera,
second processing of estimating a height of the detected moving object,
third processing of estimating a height of the position reference point based on the image of the moving object and an estimated height estimated by the second processing,
fourth processing of calculating an estimated position candidate of the moving object based on the height of the point in the area, the position of the position reference point, and the height of the position reference point, which is estimated by the third processing,
fifth processing of calculating a likelihood of the estimated position candidate based on a height in the area, the height of the position reference point, which is estimated by the third processing, and the estimated position candidate calculated by the fourth processing, and
sixth processing of determining an estimated position of the moving object based on the likelihood of the estimated position candidate, which is calculated by the fifth processing.

8. The object position estimation method according to claim 7, wherein
the moving object is a person, and
in the second processing, a fixed length is set as an estimated height of the person.

9. The object position estimation method according to claim 7, wherein
in processing of estimating the height of the position reference point by the third processing,
a skeleton is detected from the image of the detected moving object to estimate a posture of the moving object based on a position or an angle of the skeleton, and the height of the position reference point is estimated in accordance with the estimated height.

10. The object position estimation method according to claim 7, further comprising:
seventh processing of calculating a feature amount of the image of the detected moving object, wherein
in the fifth processing, the likelihood of the estimated position candidate is calculated using the feature amount calculated by the seventh processing.

11. The object position estimation method according to claim 7, further comprising:
by the storage unit,
storing a detected-object information table for managing coordinates indicating a position of a detected image, the feature amount, the estimated height of the moving object, the position reference point, and estimated reference-point height, in association with an object ID assigned to each object detected from the image, and
an object-position candidate information table for managing a camera ID unique to the camera, the object ID, and information of an estimated object-position candidate, which expresses object position in three-dimensional coordinates.
